(19) United States
(12) Patent Application Publication
(10) Pub. No.: US 2023/0402959 A1
(43) Pub. Date: Dec. 14, 2023

(54) SYSTEM AND METHODOLOGY THAT FACILITATES SOLAR PANEL ADJUSTMENTS

(71) Applicant: Tezca Inc., Tustin, CA (US)

(72) Inventors: Andre Troncoso, Irvine, CA (US); Adrian Troncoso, Irvine, CA (US); Mikhail Chakholski, Santa Ana, CA (US)

(21) Appl. No.: 18/109,186

(22) Filed: Feb. 13, 2023

Related U.S. Application Data
(60) Provisional application No. 63/309,428, filed on Feb. 11, 2022.

(51) Int. Cl. H02S 20/32

(52) U.S. Cl. CPC H02S 20/32

(57) ABSTRACT

Aspects directed towards facilitating solar panel adjustments are disclosed. In one example, an array of tiltable solar panel units are coupled to a roof, and environmental conditions proximate to the array of tiltable solar panel units are monitored. An orientation of the array of tiltable solar panel units is then adjusted based on the environmental conditions. In another example, a solar panel apparatus is provided, which includes a frame unit that has at least one solar panel, and an actuator configured to lift and lower the frame unit. For this example, the actuator further includes a wheel attachment configured to facilitate a tilting of the frame unit that varies as the actuator lifts and lowers the frame unit.

### CROSS-REFERENCE TO RELATED APPLICATIONS

This application claims the benefit of U.S. Provisional Patent Application Ser. No. 63/309,428, filed Feb. 11, 2022, which is titled “SYSTEM AND METHODOLOGY THAT FACILITATES SOLAR PANEL ADJUSTMENTS” and its entire contents of which are incorporated herein by reference.

### TECHNICAL FIELD

The subject disclosure generally relates to solar panels, and more specifically to a system and methodology that facilitates solar panel adjustments.

### BACKGROUND

Solar energy is the cleanest and most abundant renewable energy source available. Solar technologies can harness this energy for a variety of uses, including generating electricity. Indeed, an increasing number of homes are now equipped with solar panels to generate electricity for both the home and the electricity grid. The efficacy of a residential solar panel system depends on many factors though, including the orientation of the solar panels relative to the sun. As illustrated in FIG. 1, however, solar panels are typically mounted flat onto a residential roof such that the orientation is permanently fixed in a particular direction. Namely, because the orientation of conventional solar panels remains fixed, they lose efficacy in the portions of the day when the sun is not directly orthogonal to the orientation.

Accordingly, it would be desirable to provide a system and method which overcomes these limitations. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with facilitating solar panel adjustments. In one such aspect, a method is disclosed which includes coupling an array of tiltable solar panel units to a roof, and monitoring environmental conditions proximate to the array of tiltable solar panel units. The method then further includes adjusting an orientation of the array of tiltable solar panel units based on the environmental conditions.

In another aspect, a solar panel system is provided. Within such embodiment, the system includes an array component, a monitoring component, and an adjustment component. The array component comprises an array of tiltable solar panel units, and the monitoring component is configured to monitor environmental conditions proximate to the array of tiltable solar panel units. The adjustment component is then configured to adjust an orientation of the array of tiltable solar panel units based on the environmental conditions.

In yet another aspect, a solar panel apparatus is provided. The solar panel apparatus comprises a frame unit that includes at least one solar panel, and an actuator configured to lift and lower the frame unit. For this particular embodiment, the actuator further includes a wheel attachment configured to facilitate a tilting of the frame unit that varies as the actuator lifts and lowers the frame unit.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 is an illustration of a house with a conventional solar panel system;

FIG. 2 is an illustration of a house with an exemplary adjustable solar panel system according to an aspect of the subject specification;

FIG. 3 is a schematic of an exemplary solar unit in various orientations in accordance with an aspect of the subject specification;

FIG. 4 is a top view of an exemplary solar unit array in accordance with an aspect of the subject specification;

FIG. 5 is a side view of the exemplary solar unit array illustrated in FIG. 4 in a morning orientation;

FIG. 6 is a side view of the exemplary solar unit array illustrated in FIG. 4 in an afternoon orientation;

FIG. 7 is a top view of an exemplary solar unit array in accordance with another aspect of the subject specification;

FIG. 8 is a schematic of the exemplary tilt adjustment mechanism illustrated in FIG. 6;

FIG. 9 is a side view of the exemplary solar unit array illustrated in FIG. 6;

FIG. 10 illustrates a block diagram of an exemplary management system that facilitates implementing aspects disclosed herein;

FIG. 11 is a flow diagram of an exemplary methodology that facilitates adjusting solar panels in accordance with an aspect of the subject specification;

FIG. 12 is a photo illustrating an isometric view of an exemplary wheel attachment in accordance with an aspect of the subject specification;

FIG. 13 is a photo illustrating an isometric view of an exemplary coupling of a frame and wheel attachment in accordance with an aspect of the subject specification;

FIG. 14 is a photo illustrating an exemplary linear actuator of a solar panel apparatus in accordance with an aspect of the subject specification;

FIG. 15 is an exemplary module subsystem electrical diagram in accordance with an aspect of the subject specification;

FIG. 16 is an exemplary electrical subsystem flow diagram in accordance with an aspect of the subject specification;

FIG. 17 is an exemplary power flow diagram in accordance with an aspect of the subject specification;

FIG. 18 is an exemplary communication subsystem diagram in accordance with an aspect of the subject specification;

FIG. 19 is an exemplary mechanical subsystem support diagram in accordance with an aspect of the subject specification;

FIG. 20 is a flow diagram illustrating an exemplary process for ascertaining an optimal power generation angle in accordance with an aspect of the subject specification;

FIG. 21 is a system flow chart of an exemplary dual-axis solar tracker of a solar panel apparatus in accordance with an aspect of the subject specification;

FIG. 22 is a system diagram illustrating exemplary subsystems of a solar panel apparatus in accordance with an aspect of the subject specification;

FIG. 23 is a schematic diagram illustrating a top, side, and perspective view of an exemplary solar unit in accordance with an aspect of the subject specification;

FIG. 24 is an exemplary state flow diagram in accordance with an aspect of the subject specification;

FIG. 25 is a schematic diagram illustrating exemplary microcontroller connections in accordance with an aspect of the subject specification;

FIG. 26 is a schematic diagram illustrating an exemplary system power flow in accordance with an aspect of the subject specification;

FIG. 27 illustrates an exemplary solar panel apparatus in accordance with a first aspect of the subject specification;

FIG. 28 illustrates an exemplary solar panel apparatus in accordance with a second aspect of the subject specification;

FIG. 29 illustrates an exemplary solar panel apparatus in accordance with a third aspect of the subject specification;

FIG. 30 is a block diagram representing exemplary non-limiting networked environments in which various embodiments described herein can be implemented; and

FIG. 31 is a block diagram representing an exemplary non-limiting computing system or operating environment in which one or more aspects of various embodiments described herein can be implemented.

### DETAILED DESCRIPTION

### Overview

As discussed in the background, it is desirable to provide a system and method which overcomes the various limitations of conventional solar panel systems. The embodiments disclosed herein are directed towards overcoming such limitations by providing an automated solar panel adjustment system. For instance, in a particular embodiment, a solar panel adjustment system is disclosed, which is configured to incrementally adjust the orientation of the solar panels throughout the day to track the path of the sun.

For reference, it should be noted that a solar panel array with a flat orientation is limited in comparison to a solar panel array having a variable orientation as disclosed herein. Namely, the power generation of a solar panel array with variable orientation produces greater power than that of a flat solar panel array because an optimal orientation of a solar panel array is orthogonal to the solar rays emanating from the sun and directed towards to earth. Indeed, the aspects disclosed herein provide variable degrees of freedom that enable the set of panels to be oriented such that power generated surpasses the power generated by fixed panels.

In a particular aspect disclosed herein, an optimal orientation is determined by a solar tracker device that may be configured to face the sun during the day and would inform the tilting mechanism of the proper orientation to face the panels. It is contemplated, however, that such tilting raises the concern of a wind's uplift force potentially damaging the system by causing it to vibrate and potentially break the frame. To mitigate such concern, it is contemplated that a weather tracking device can be utilized to inform the system of incoming high winds and to safely reorient the panel array to a position in which drag is minimal (e.g., a neutral position).

The performance of the system disclosed herein may be monitored by measuring the generated and consumed power, which may be transmitted to an in-house server where it can be stored and compartmentalized by a user. The system performance and utility savings data may be sent to a user's smart phone, for example, where it can be displayed in the form of graphs, values, and figures. Indeed, it is contemplated that a user may utilize a smart phone application to monitor various performance metrics of the system including, but not limited to, the amount of power generated by the system and the consumption rate of the system.

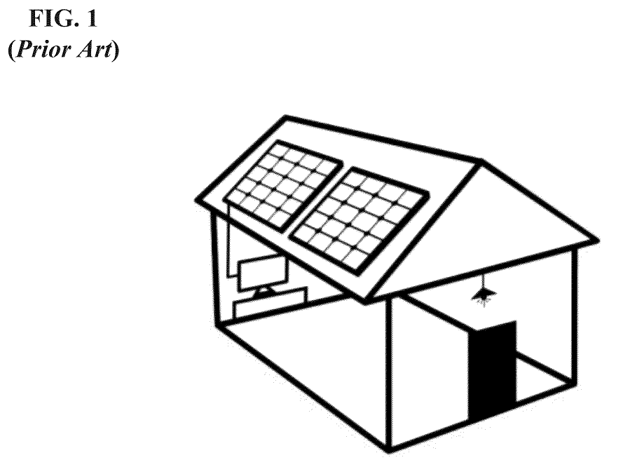

It should be appreciated that the aspects disclosed herein are particularly desirable in the residential market, especially homes with pitched roofs. Indeed, unlike conventional systems that have a fixed/zero degree of freedom, such as the system illustrated in FIG. 1, the aspects disclosed herein enable the solar panels to track the location of the sun via multiple degrees of freedom. For instance, in an exemplary embodiment, an increase in power generation is achieved by lifting a set of solar panels using an apparatus comprising a linear actuator, frame, and wheel, wherein an optimal angle/orientation of the solar panels is determined by a solar tracker (e.g., having two degrees of freedom). The solar tracker may, for example, determine the azimuth and elevation of the sun through an interactive process.

### Exemplary Advantages

Exemplary advantages of the aspects disclosed herein are now discussed relative to conventional systems.

First, exemplary advantages of the aspects disclosed herein are discussed relative to the designs included in International Patent Publication No. WO2020185271A1 by Palmer et. al (hereinafter “Palmer”), which is hereby incorporated by reference in its entirety. The design disclosed in Palmer is loosely based on the concept of a rocking chair that can move back and forth depending on the desired orientation, wherein a linear actuator is used to reorient a frame and rocker that holds a row of solar panels. On one side of the solar panel row, there is a solar tracker that finds the most optimal elevation. However, this design is generally directed towards commercial/industrial buildings where the degrees of freedom in which it operates is singular.

The aspects disclosed herein are different than the Palmer design in various ways. For instance, the aspects disclosed herein contemplate a multiple axis design, which generally achieves greater energy yields than single-axis systems. Also, whereas Palmer is directed towards commercial applications (e.g., in open fields or commercial buildings in which roofs are flat), aspects disclosed herein encompass residential applications (e.g., where roofs may be flat or pitched).

Other conventional systems include a “flower-style” solar panel system introduced by Smartflower Solar (hereinafter “Smartflower”). The Smartflower system uses petal shaped blades to generate electricity, wherein the blades spread 360 degrees around the base to provide maximum effective contact area with the solar rays. Here, however, although the Smartflower design includes solar tracking capabilities, it is not designed for roof installation. Instead, the Smartflower design is designed for installation adjacent to buildings, which makes it is difficult to scale because of shadows and the space required to produce the maximum amount of power generation.

### Exemplary Embodiments

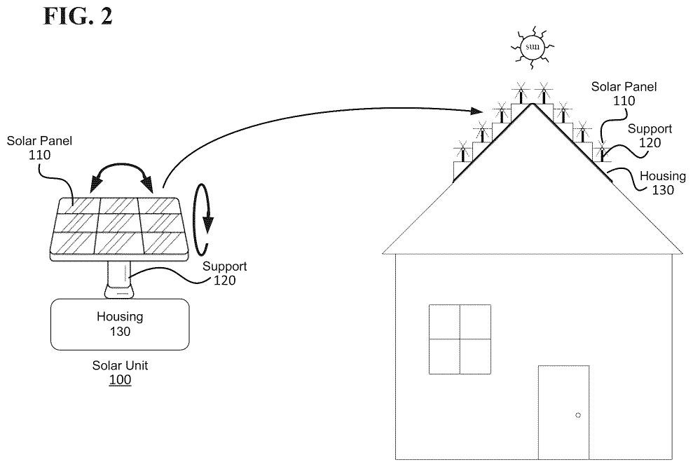

Various exemplary embodiments in accordance with aspects disclosed herein are illustrated in FIGS. 2-29.

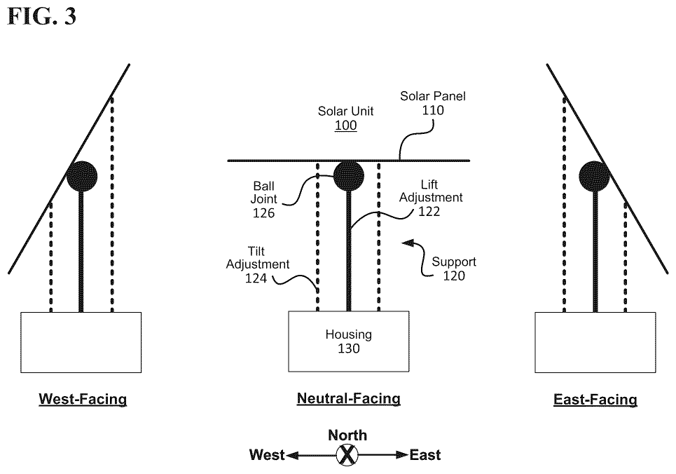

With reference to FIGS. 2-5, a solar unit system in accordance with a first aspect disclosed herein is provided. For instance, FIG. 2 is an illustration of a house with an exemplary adjustable solar panel system. As illustrated, it is contemplated that a solar unit 100 may comprise a solar panel 110, a support 120, and a housing 130. Within such embodiment, it is further contemplated that solar unit 100 may be configured to install onto a roof, including a pitched roof such as the roof illustrated in FIG. 2, wherein solar panel 110 may be configured to adjust on multiple axes. For instance, as illustrated in FIG. 3, support 120 may be configured to adjust solar panel 110 on multiple axes, via a mechanism comprising tilt adjustment 124 and ball joint 126. For this particular example, although an adjustment is shown in which solar panel 110 variably adjusts from an east-facing orientation (e.g., in the morning), to a neutral-facing orientation (e.g., mid-day), and then to a west-facing orientation (e.g., in the afternoon), it is contemplated that ball joint 126 can facilitate orienting solar panel 110 on multiple axes including, for example, in a north-facing orientation and/or a south-facing orientation (e.g., to facilitate seasonal adjustments). Moreover, it is contemplated that ball joint 126 may be configured to facilitate 360-degree adjustments of solar panel 110.

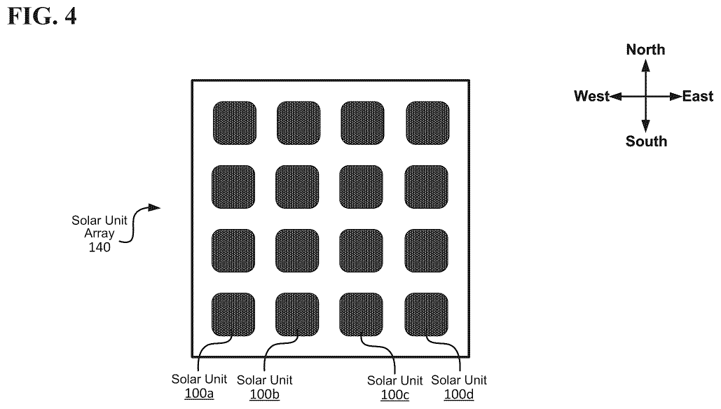

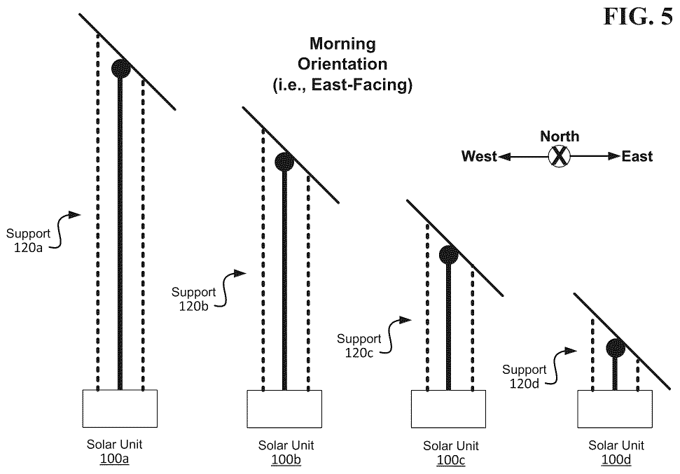

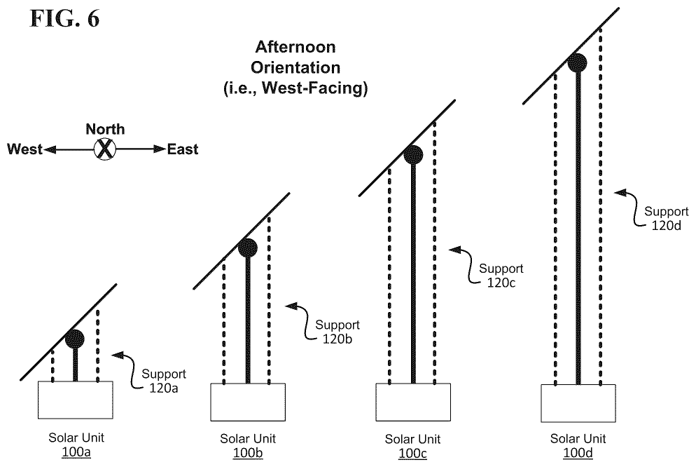

It is also contemplated that support 120 may be configured to lower and raise solar panel 110 via lift adjustment 122. Having such capability is particularly desirable to avoid shadows from adjacent solar units 100 of an array 140. For instance, as illustrated in FIG. 4, it is contemplated that a solar unit array 140 may be arranged on a roof, wherein the solar unit array 140 may include solar units 100a, 100b, 100c, and 100d. In this example, it is further contemplated that solar units 100a, 100b, 100c, and 100d may be configured to respectively lift to different heights so as to mitigate shadows from adjacent solar units as their respective solar panels track the sun throughout the day. For example, FIG. 5 shows a side view of solar units 100a, 100b, 100c, and 100d in a morning orientation (i.e., east-facing), whereas FIG. 6 shows a side view of solar units 100a, 100b, 100c, and 100d in an afternoon orientation (i.e., west-facing).

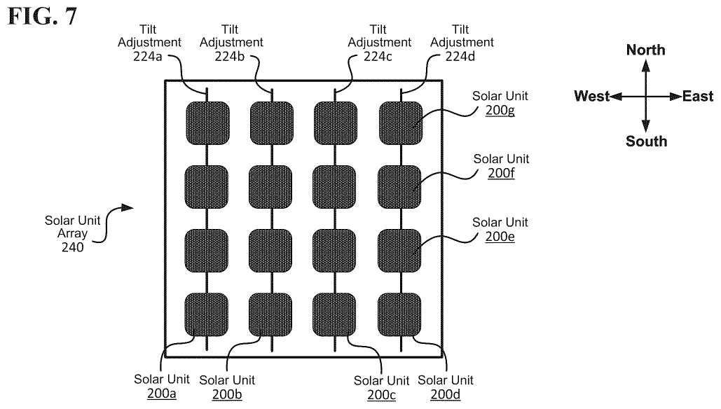

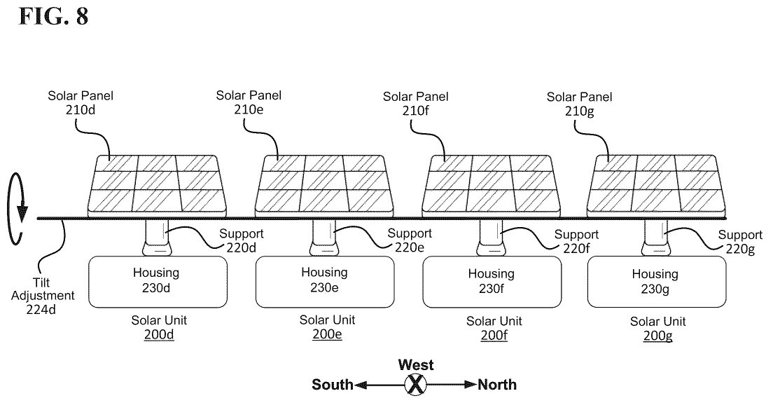

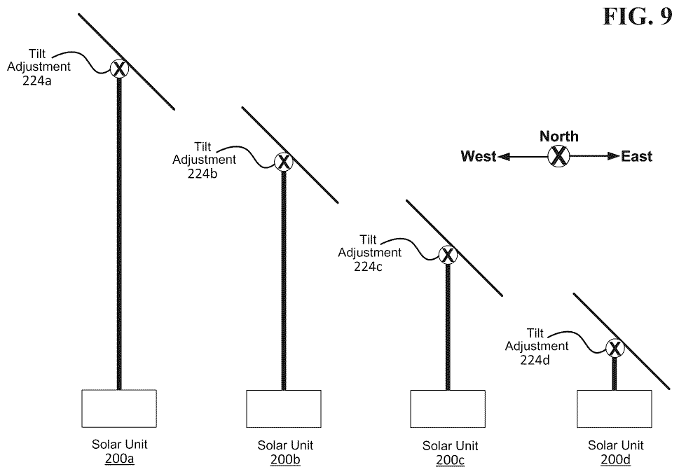

With reference to FIGS. 7-9, a solar unit system in accordance with a second aspect disclosed herein is provided. For this particular embodiment, it is contemplated that a solar unit array 240 comprises various solar units including, for example, solar units 200a, 200b, 200c, 200d, 200e, 200f, and 200g, as shown, wherein each of solar units 200a, 200b, 200c, 200d, 200e, 200f, and 200g are substantially similar to solar unit 100 illustrated in FIG. 2. Here, however, it is further contemplated that rows of solar units may be coupled to each other via a common tilt adjustment mechanism. For instance, as illustrated in FIG. 7, solar unit array 240 may include tilt adjustment 224a, 224b, 224c, and 224d, wherein each of 224a, 224b, 224c, and 224d is configured to simultaneously and uniformly tilt solar units in a particular row. Indeed, as illustrated in FIG. 8, tilt adjustment 224d may be configured to rotate so as to simultaneously and uniformly tilt solar units 200d, 200e, 200f, and 200g. As illustrated in FIG. 9, it is also contemplated that tilt adjustments 224a, 224b, 224c, and 224d may be configured to facilitate simultaneously and uniformly lifting solar units in respective rows. Indeed, FIG. 9 shows a side view of solar unit array 240, wherein rows respectively corresponding to solar units 200a, 200b, 200c, and 200d are raised to different heights. Here, although an east-facing orientation is shown (e.g., for the morning), it should be appreciated that the heights of each row can be adjusted so as to track the path of the sun throughout the day (e.g., a west-facing orientation in the afternoon).

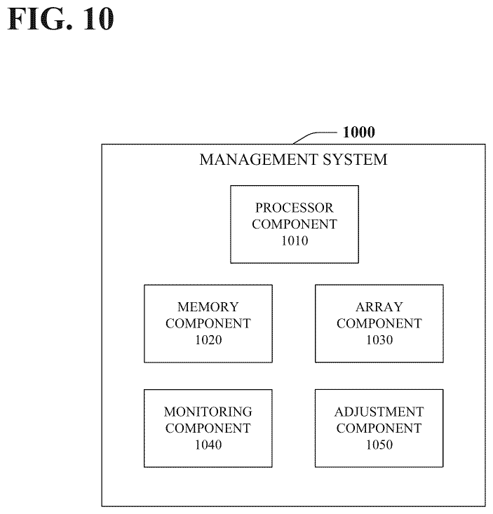

In a further embodiment, it is contemplated that aspects disclosed herein may be implemented within a computer-based system. Referring next to FIG. 10, an exemplary block diagram of such a system is provided. As illustrated, management system 1000 may include a processor component 1010, a memory component 1020, a array component 1030, a monitoring component 1040, and an adjustment component 1050. Components 1010-1040 may reside together in a single location or separately in different locations in various combinations, including, for example, a configuration in which at least one of the aforementioned components reside in a cloud.

In one aspect, processor component 1010 is configured to execute computer-readable instructions related to performing any of a plurality of functions. Processor component 1010 can be a single processor or a plurality of processors which analyze and/or generate information utilized by memory component 1020, array component 1030, monitoring component 1040, and/or adjustment component 1050. Additionally or alternatively, processor component 1010 may be configured to control one or more components of management system 1000.

In another aspect, memory component 1020 is coupled to processor component 1010 and configured to store computer-readable instructions executed by processor component 1010. Memory component 1020 may also be configured to store any of a plurality of other types of data including data generated by any of array component 1030, monitoring component 1040, and/or adjustment component 1050. Memory component 1020 may be configured to store any of several types of information explained above, including orientations that have historically generated the most power on particular days in a location, for example.

Memory component 1020 can be configured in a number of different configurations, including as random access memory, battery-backed memory, Solid State memory, hard disk, magnetic tape, etc. Various features can also be implemented upon memory component 1020, such as compression and automatic back up (e.g., use of a Redundant Array of Independent Drives configuration). In one aspect, the memory may be located on a network, such as a “cloud storage” solution.

In a particular embodiment, it is contemplated that array component 1030 may comprise an array of tiltable solar panel units (e.g., solar unit array 140 or solar unit array 240), whereas monitoring component 1040 may be configured to monitor environmental conditions proximate to the array of tiltable solar panel units (e.g., a position of the sun, wind conditions, etc.). Within such embodiment, adjustment component 1050 may then be configured to adjust an orientation of the array of tiltable solar panel units based on the environmental conditions (e.g., tracking the position of the sun, adjusting a height and/or orientation of a solar unit to mitigate damage from wind, etc.).

In a particular embodiment, it is contemplated that monitoring component 1040 may be used to interface management system 1000 with external entities. For example, monitoring component 1040 may be configured to receive data via a network, such as data corresponding to environmental conditions (e.g., position of the sun, wind conditions, etc.). Furthermore, it is contemplated that various aspects of management system 1000 may be controlled/monitored remotely (e.g., from a smartphone, laptop, etc.). Accordingly, it should be appreciated that monitoring component 1040 may be implemented using any of various communication protocols known in the art (e.g., Bluetooth, WiFi, etc.).

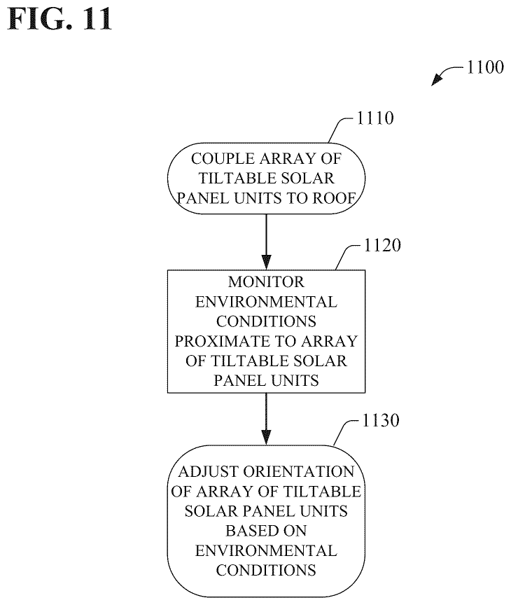

Referring next to FIG. 11, a flow chart illustrating an exemplary method that facilitates aspects disclosed herein is provided. As illustrated, process 1100 includes a series of acts that may be performed by a system (e.g., management system 1000) according to an aspect of the subject specification. For instance, process 1100 may be implemented by employing a processor to execute computer executable instructions stored on a computer readable storage medium to implement the series of acts. In another embodiment, a computer-readable storage medium comprising code for causing at least one computer to implement the acts of process 1100 is contemplated.

As illustrated, process 1100 begins with the coupling of an array of tiltable solar panel units to a roof at act 1110 (e.g., an electronic coupling between a remote device and a control unit located on a particular solar unit). At act 1120, the management system 1000 then begins to monitor environmental conditions proximate to the array of tiltable solar panel units (e.g., location of the sun, wind conditions, etc.). Process 1100 then concludes at act 1130 where the management system 1000 adjusts an orientation of the array of tiltable solar panel units based on the environmental conditions.

It should be appreciated that various exemplary implementations of the aspects disclosed herein are contemplated. For instance, an exemplary solar panel apparatus may include a frame unit comprising at least one solar panel and an actuator configured to lift and lower the frame unit. Within such embodiment, it is contemplated that the actuator may further comprise a wheel attachment configured to facilitate a tilting of the frame unit that varies as the actuator lifts and lowers the frame unit. In a further aspect, it is contemplated that a frame with a set of solar panels is lifted by two linear actuators.

It should be noted that the electronics that provide the solar tracking and weather tracking may reside within the apparatus itself (e.g., within housing 130 for solar unit 100) and/or in a remote unit. It is also contemplated that a reinforced bracket may be used to hold the two linear actuators, wherein the bracket maybe bolted onto the rafters of the roof to provide structural support when the panels are lifted. A roof jack may be included as well, which may serve as a moisture and dust buffer between the outside and inside the home (e.g., accommodated by flashing & watertight sealer to prevent water seepage through the opening where the shaft actuator is located). In a particular embodiment, the solar panel apparatus uses a micro-inverter that converts DC power into AC power, wherein the AC power is sent to the energy grid.

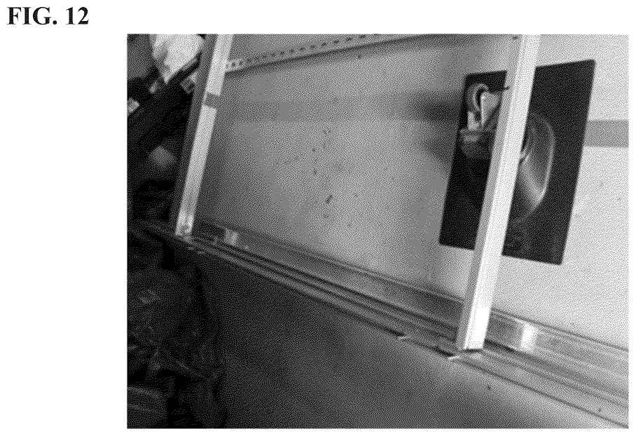

Referring next to FIGS. 12-26, illustrations of various exemplary implementations of the aspects disclosed herein are provided. In FIG. 12, for instance, a photo illustrating an isometric view of an exemplary wheel attachment is provided. As illustrated, an exemplary assembly may include a wheel attachment, a frame, and a roof jack. The wheel attachment may be fixed to a linear actuator shaft, and may have the shape of a hallow box. It is also contemplated that the linear actuator shaft and the wheel attachment may be held together by a screw and nut.

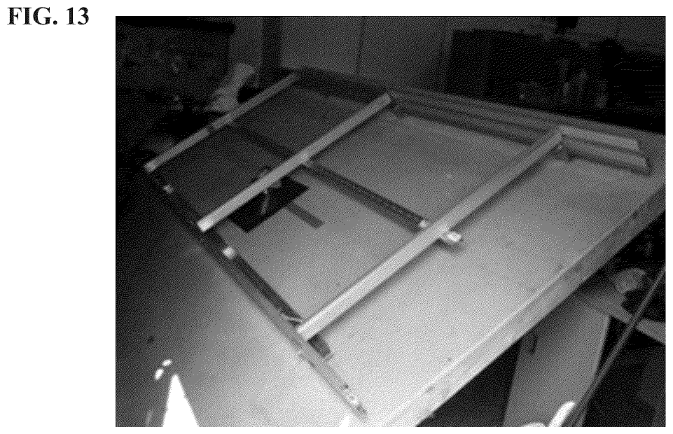

Referring next to FIG. 13, a photo illustrating an isometric view of an exemplary coupling of a frame and wheel attachment is provided. Here, it should be noted that FIG. 13 shows a different angle of FIG. 12. As illustrated, it is contemplated that there may be a rail in the center that contacts the wheel, wherein the rail guides the wheel as the linear actuator moves vertically in reference to the house. Hence, the upper frame is lifted upward and forms a tilt angle with the lower frame and the roof. The tilt angle may facilitate an increase in generated power for the home or business. In an exemplary embodiment, rather than using nuts and bolts, it should be appreciated that welds may be used. Indeed, since welds may be much stronger and cost effective than nuts and bolts, such a design may be more desirable for keeping the frame interact (i.e., for purposes of safety and integrity).

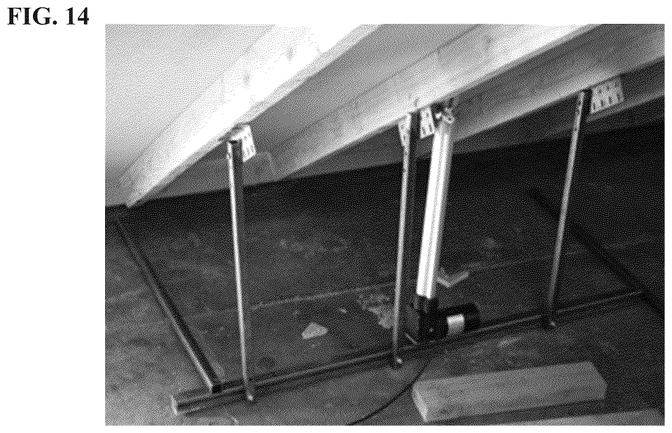

Referring next to FIG. 14, a photo illustrating an exemplary linear actuator of a solar panel apparatus is provided. As illustrated, it is contemplated that a liner actuator mount may be bolted to the rafters of a pitched roof. It should be noted that the formation of the beams may be considered when mounting a linear actuator since they provide mechanical support for the actuator and by extension the frame of the solar panel module.

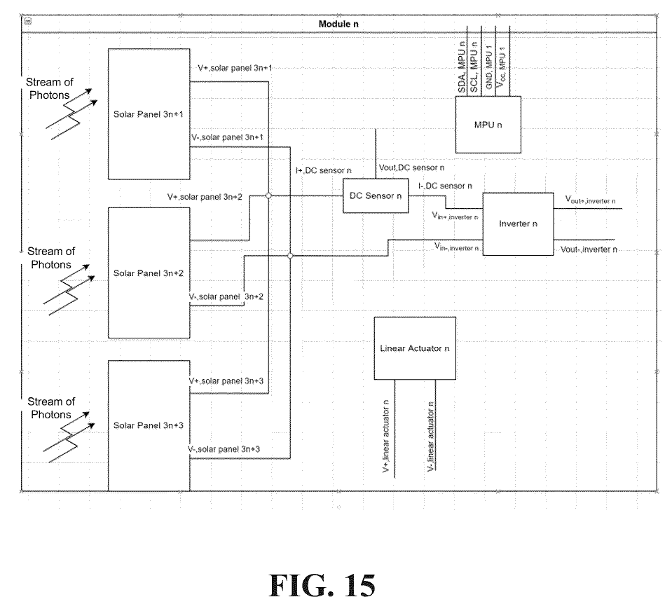

Referring next to FIG. 15, an exemplary module subsystem electrical diagram is provided. As illustrated, each module may include three solar panels, one DC sensor, one inverter, one linear actuator, and one MPU. The MPU may be a gyroscope sensor that measures the angle of the individual module, and the linear actuator may be the component that provides the said angle with a lifting force onto the frame. The DC sensor is synonymous with the DC power monitor since a power monitor can measure both voltage and current across and through its terminals respectively. The inverter converts the DC power generated by the solar panels into AC power where it is convoluted with the outputs of the other inverters and delivered to the grid where it can be used by the home or business, for example. The number of modules that can be controlled by a single microcontroller may be called n and it may directly affect the number of digital, analog, and PWM ports used within the microcontroller.

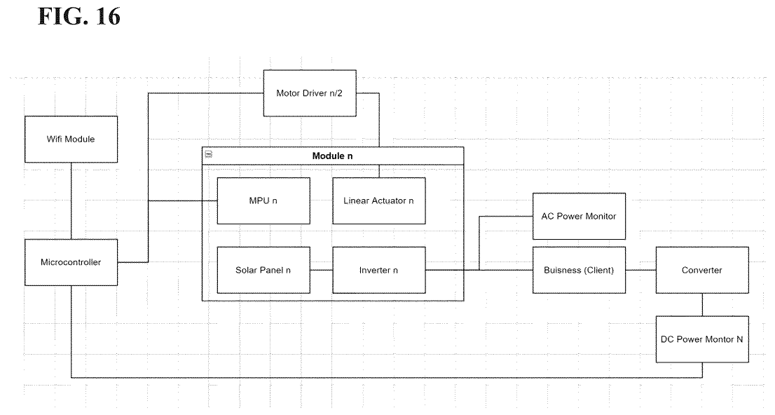

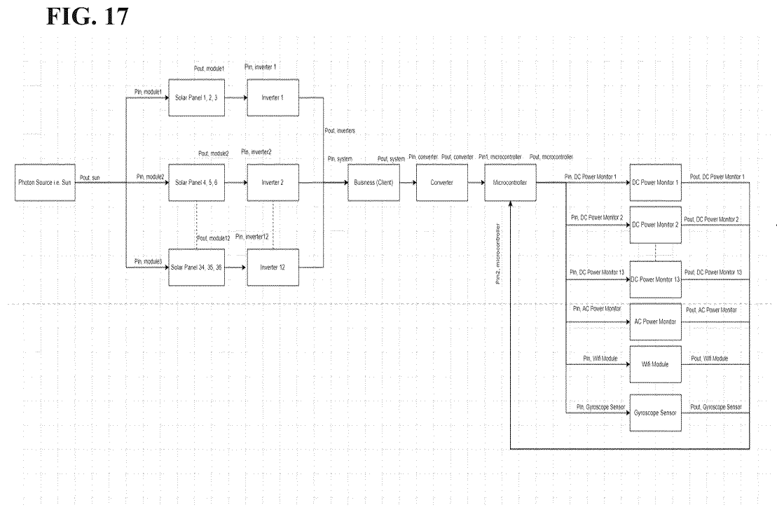

Referring next to FIG. 16, an exemplary electrical subsystem flow diagram is provided. As illustrated, it is contemplated that a microcontroller may be used as the primary control unit of the entire system. For instance, the microcontroller may be configured to direct the moment each module is lifted and to what degree it should be lifted. In a particular embodiment, the number of motor drivers required to lift two modules is one, wherein the modules can be individually controlled. The MPU (gyroscope sensor) may provide the microcontroller with angle data which is used to determine the most optimal solar power generation angle. The AC power monitor may display the amount of power provided and consumed, whereas the DC power monitor may be configured to send data to the microcontroller regarding the amount of power used by the system which may includes any combination of the following (all sensors and all motors): microcontroller, AC power monitor, linear actuators, MPU, motor drivers, DC power monitors.

Referring next to FIG. 17, is an exemplary power flow diagram is provided. Here, it should be noted that the power flow diagram is oriented in the direction of power supplied. In other words, the direction of the array is in the direction of power supplied, which means that the Sun provides positive power to the solar panels. The power entering into the component and the power exiting the component is labeled accordingly.

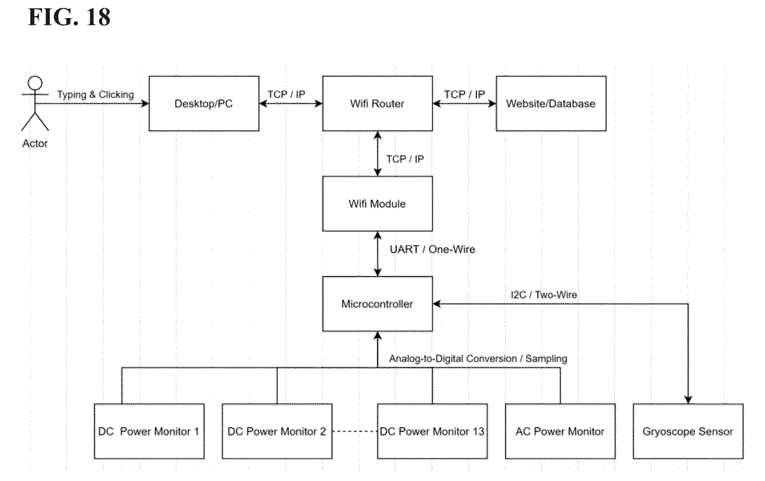

Referring next to FIG. 18, is an exemplary communication subsystem diagram is provided. As illustrated, it is contemplated that the communication subsystem is informatically related to the solution. For instance, a user may interact with a desktop to discover the performance of the system within their property. The desktop then sends requests made by the user to the Wi-Fi router which gets relayed via a series of networking nodes to a website/database. The website/database may then respond to the user with regards to the data that is sent from the Wi-Fi module of the paired system (the pair is established before the system is setup). The Wi-Fi module may thus act as an interface between the microcontroller and the internet which is a series of networking nodes that act in concordance to transfer data as effectively and efficiently to the desired destination. The website may be the interface between the user and the Wi-Fi module which is capable of graphing data that aligns with the user's interests because of the economical implications of energy consumption. In essence, all the data that is generated by the sensors can be transmitted to the server for rendering and storage.

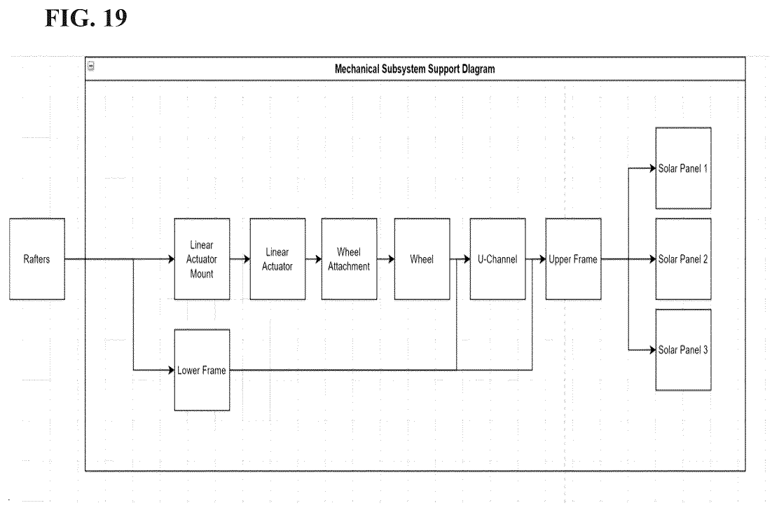

Referring next to FIG. 19, is an exemplary mechanical subsystem support diagram is provided. Here, it should be appreciated that the mechanical subsystem support diagram indicates the direction of support of each mechanical component. Namely, the direction of the arrows aligns with the direction of mechanical support. The rafters may provide support for the lower frame and the linear actuator mount. The linear actuator mount may hold the linear actuator and its attachment. The force generated by the linear actuator may then be applied to the U-channel which by mechanical dependence moves the upper frame to an angle determined by the microcontroller. The solar panels may be fixed to the upper frame which may provide most, if not all, of the mechanical integrity.

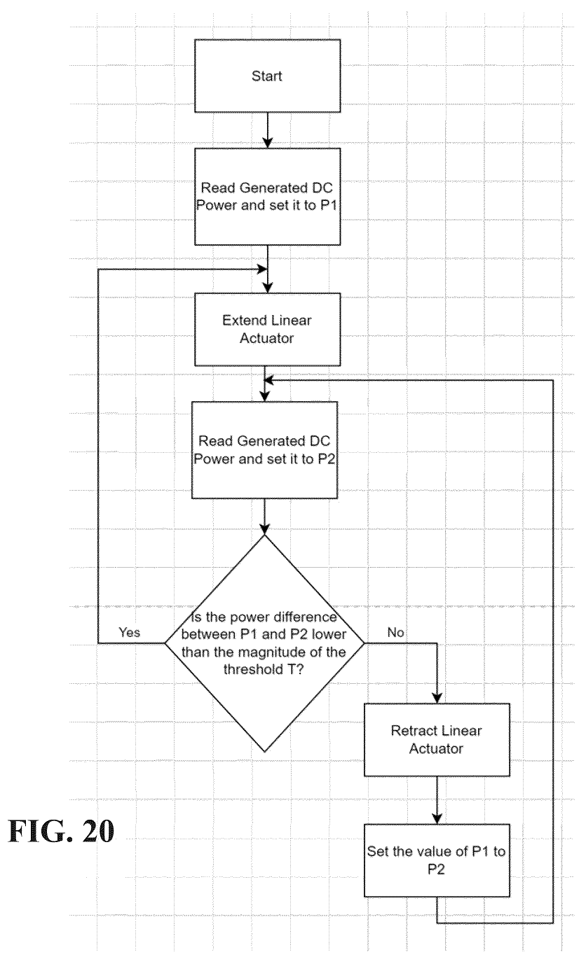

Referring next to FIG. 20, is a flow diagram illustrating an exemplary process for ascertaining an optimal power generation angle is provided. Here, it is contemplated that the microcontroller may ascertain the most optimal power generation angle via an interactive process. For instance, the algorithm may start by assuming that the direction of the best power generation is in in the direction of linear actuator extension. It may then calculate the difference of the generated DC power and compare it with a threshold. If it is below the threshold then it may retract the linear actuator, otherwise it may continue extending the linear actuator.

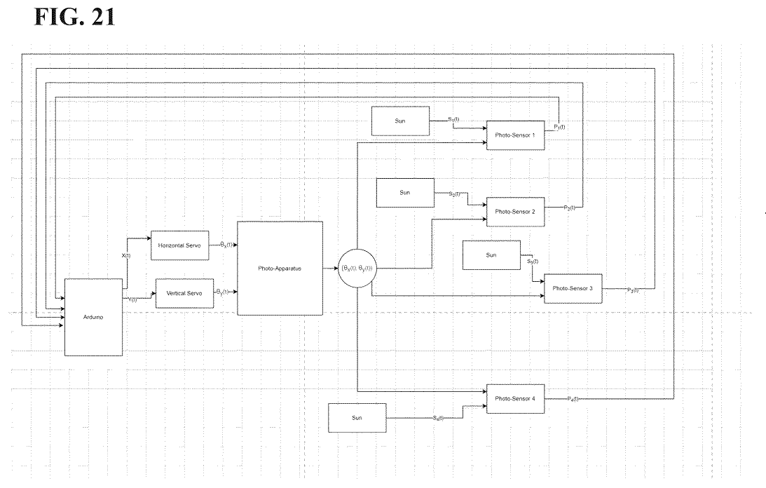

Referring next to FIG. 21, a system flow chart is provided for an exemplary dual-axis solar tracker configured to locate an optimal elevation for solar power generation. Within such embodiment, the aforementioned optimal angle may be ascertained through an interactive process provided by the PLC programmable logic computer (e.g., an Arduino processor). It is further contemplated that vertical and horizontal servos may provide an angle for a photo-apparatus that includes four photo-sensors configured to find a light offset based on an orientation of the device. Such offset may be minimized by carefully controlling the servos and by extension the photo-apparatus.

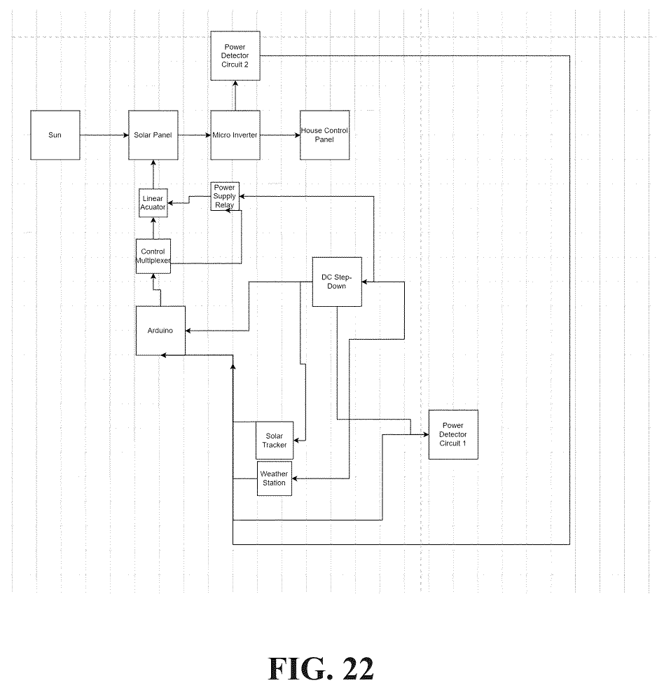

Referring next to FIG. 22, a system flow chart is provided illustrating exemplary subsystems of a solar panel apparatus in accordance with aspects disclosed herein. As illustrated, such apparatus may include a solar panel, a linear actuator, a control multiplexer, and an Arduino processor. The apparatus may further include power detector circuits, a solar tracker, and a weather station. Here, it is contemplated that the power detector circuits may include a communication circuit, a voltmeter circuit, and an ammeter circuit. Data ascertained by the voltmeter and/or ammeter circuits may be sent to the communication circuit where it may be transmitted to a website/server application for smart phone rendering. The PLC, which in this case is an Arduino processor, may provide the control of the linear actuator.

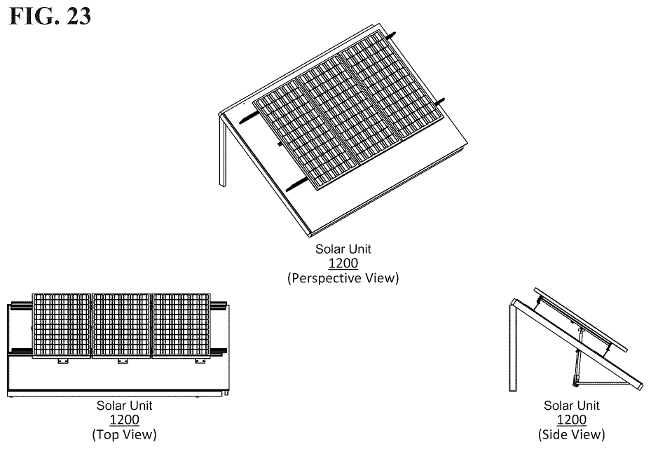

Referring next to FIG. 23 a schematic diagram is provided illustrating a top, side, and perspective view of an exemplary solar unit 1200 in accordance with an aspect of the subject specification.

In another aspect disclosed herein, the use of Wi-Fi and Bluetooth is contemplated to monitor and setup the solar unit apparatus. For instance, the Bluetooth subsystem may provide the system with initial conditions, which the Wi-Fi subsystem may later use to link the system with a user in the database. Therefore, bad actors cannot claim the device belongs to a different person. Also, a backup supply may be added to the design to allow the system to remain operational even after a power outage.

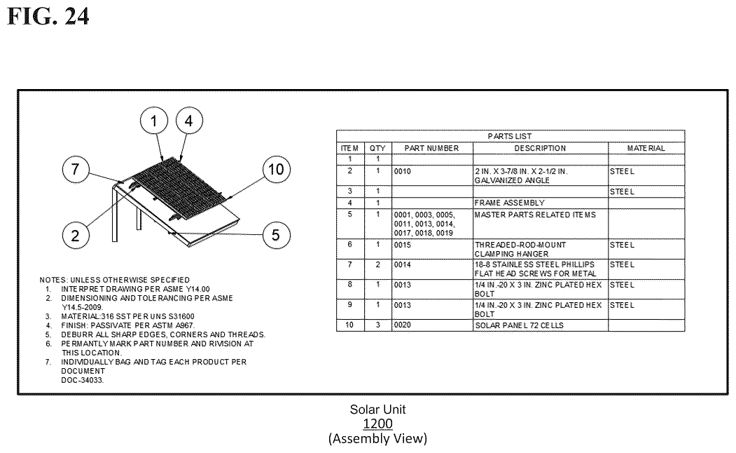

An exemplary state flow diagram in accordance with such design is provided in FIG. 24. For this particular example, A represents the idle state, B represents the setup state, C represents the active state, D represents the retreat state, and E represents the sleep state. The idle state is the default mode of the system where it may be configured to perform minimal definitive tasks, but is attentive to the pressing of the reset/set button. When this button is pressed, the system may transition to state B where the setup process is executed and may involve a connection with WiFi, Bluetooth, and sensors. Once this process is complete, the system may transition into active mode where power optimization and data collections/transmission occur. If the vibration of the system is above a threshold and/or the environmental light is below a threshold and/or the user has pressed the retreat button on the smart phone app, then the system may transition to retreat mode. In this mode, the system may transition to its normal position. Additionally, if the user decides to set the system to sleep mode, then the microcontroller may enter a deep sleep where the rate of clock cycles is reduced and memory usage is reduced. By extension, the power consumed by the microcontroller may be greatly reduced.

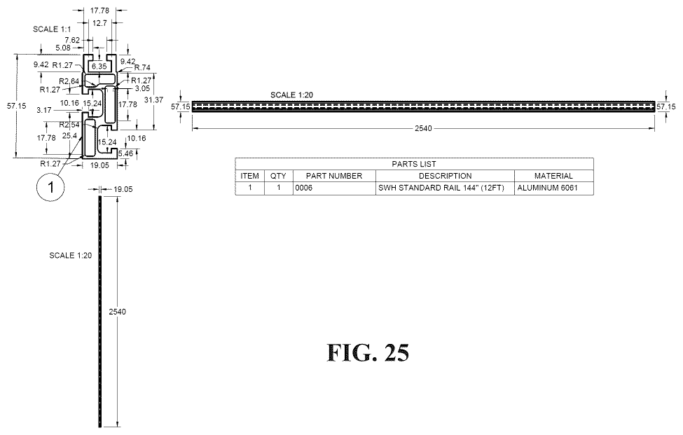

Referring next to FIG. 25, a schematic diagram illustrating exemplary microcontroller connections is provided. For this particular example, the diagram denotes the connections of an ESP32 microcontroller with an MPU6050, solar sensor, contact sensor, motor driver, buck converter, back up battery, and DC power adapter. The MPU6050 may be configured to inform the microcontroller of the following physical characteristics: pitch, tilt, yaw, and acceleration. The acceleration may be used to determine if the system is receiving excessive shock load.

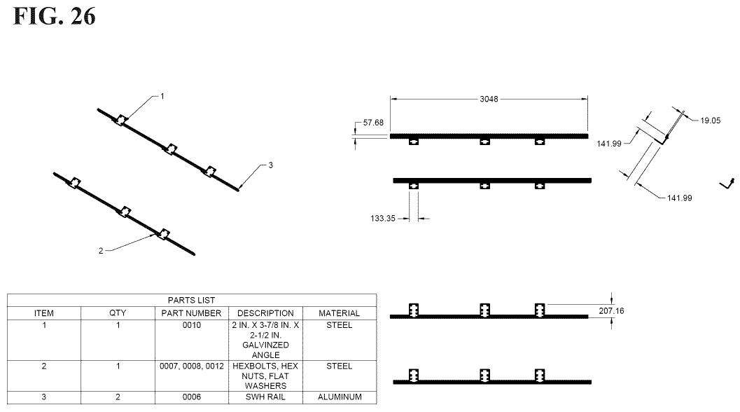

Referring next to FIG. 26, a schematic diagram illustrating an exemplary system power flow is provided. For this particular example, the diagram shows an overview of the system's power flow where the grid provides: a 120V-12V receptacle; a 120V-5V receptacle; and a separate 12V Lead-Acid battery. The 120V-12V receptacle may be configured to grant DC power access for the linear actuators and motor drivers, whereas the 120V-5V receptacle may be configured to provide the microcontrollers with the optimal voltage of 5V. In case there is a power outage, the battery system may be expected to provide power to all electrical subsystems. This ensures that no components are harmed during the outage and provides certainty for the end consumer.

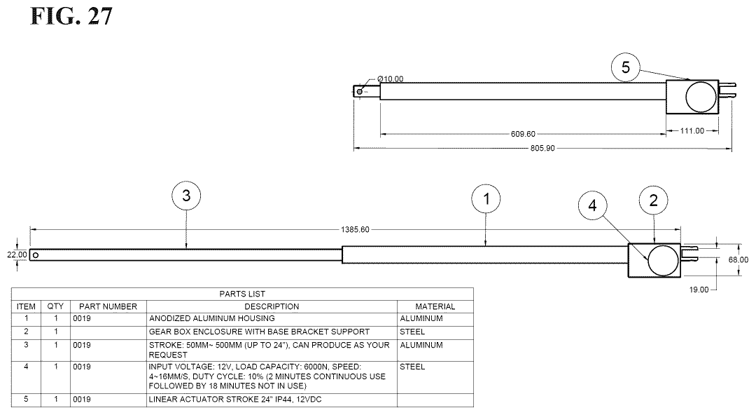

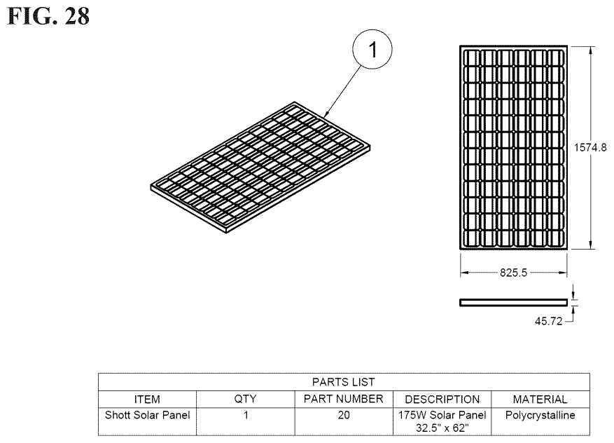

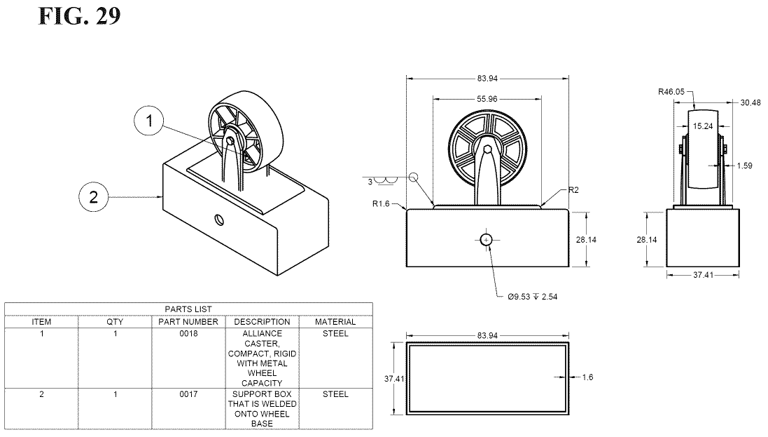

Referring next to FIG. 27, an exemplary solar panel apparatus in accordance with a first aspect of the subject specification is provided. It should be appreciated that this particular mechanical and structural design may be desirable for coupling to a roof with a flat pitch. For this embodiment, the assembly may comprise three sub-assemblies such as the skeleton, the linear actuator support, and the frame. The skeleton is the structure that provides the module with a pitch, wherein the structure is joined to the linear actuator support to ensure that the range of motion is vertical so as to prevent damage to the linear actuator stroke. The frame may comprise a Howe structure joined together by welds and a track for a cart that moves back and forth for the purpose of pitching the module, wherein such frame design may also be applicable to the embodiments described below with reference to FIGS. 28-29.

Referring next to FIG. 28, an exemplary solar panel apparatus in accordance with a second aspect of the subject specification is provided. It should be appreciated that this particular mechanical and structural design may be desirable for coupling to a pitched roof (e.g., with a pitch range between 10∘-30∘). The linear actuator support here may be different than the support used for the solar panel apparatus illustrated in FIG. 27 in the sense that it may use a custom bracket to hold the linear actuator from the top side whereas the bracket that might be used for the solar panel apparatus illustrated in FIG. 27 is commonly referred to as the ‘swivel bracket’. For instance, such custom bracket may use three rectangular tubes in parallel with a rail that connects to the linear stroke and is flush with the rail.

Referring next to FIG. 29, an exemplary solar panel apparatus in accordance with a third aspect of the subject specification is provided. Here, two different isometric views, 2900 and 2905, are provided. The first view 2900 shows the underside of a roof where the linear actuator is mounted below the solar panels to provide lift. The second view 2905 shows hinges that allow the panels to rotate around an axis alongside the spine of the mechanism. For this embodiment, a U-bracket may be placed below the linear actuator to mount it properly to the support, which is may be ideal for providing support to mitigate against potential vibrations.

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

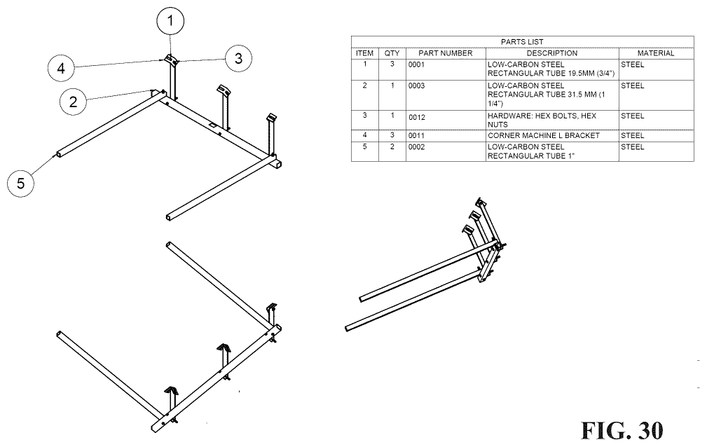

FIG. 30 provides a non-limiting schematic diagram of an exemplary networked or distributed computing environment. The distributed computing environment comprises computing objects or devices 3010, 3012, etc. and computing objects or devices 3020, 3022, 3024, 3026, 3028, etc., which may include programs, methods, data stores, programmable logic, etc., as represented by applications 3030, 3032, 3034, 3036, 3038. It can be appreciated that computing objects or devices 3010, 3012, etc. and computing objects or devices 3020, 3022, 3024, 3026, 3028, etc. may comprise different devices, such as PDAs (personal digital assistants), audio/video devices, mobile phones, MP3 players, laptops, etc.

Each computing object or device 3010, 3012, etc. and computing objects or devices 3020, 3022, 3024, 3026, 3028, etc. can communicate with one or more other computing objects or devices 3010, 3012, etc. and computing objects or devices 3020, 3022, 3024, 3026, 3028, etc. by way of the communications network 3040, either directly or indirectly. Even though illustrated as a single element in FIG. 30, network 3040 may comprise other computing objects and computing devices that provide services to the system of FIG. 30, and/or may represent multiple interconnected networks, which are not shown. Each computing object or device 3010, 3012, etc. or 3020, 3022, 3024, 3026, 3028, etc. can also contain an application, such as applications 3030, 3032, 3034, 3036, 3038, that might make use of an API (application programming interface), or other object, software, firmware and/or hardware, suitable for communication with or implementation of the disclosed aspects in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 30, as a non-limiting example, computing objects or devices 3020, 3022, 3024, 3026, 3028, etc. can be thought of as clients and computing objects or devices 3010, 3012, etc. can be thought of as servers where computing objects or devices 3010, 3012, etc. provide data services, such as receiving data from computing objects or devices 3020, 3022, 3024, 3026, 3028, etc., storing of data, processing of data, transmitting data to computing objects or devices 3020, 3022, 3024, 3026, 3028, etc., although any computer can be considered a client, a server, or both, depending on the circumstances. Any of these computing devices may be processing data, or requesting services or tasks that may implicate aspects and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 3040 is the Internet, for example, the computing objects or devices 3010, 3012, etc. can be Web servers with which the computing objects or devices 3020, 3022, 3024, 3026, 3028, etc. communicate via any of a number of known protocols, such as HTTP. As mentioned, computing objects or devices 3010, 3012, etc. may also serve as computing objects or devices 3020, 3022, 3024, 3026, 3028, etc., or vice versa, as may be characteristic of a distributed computing environment.

### Exemplary Computing Device

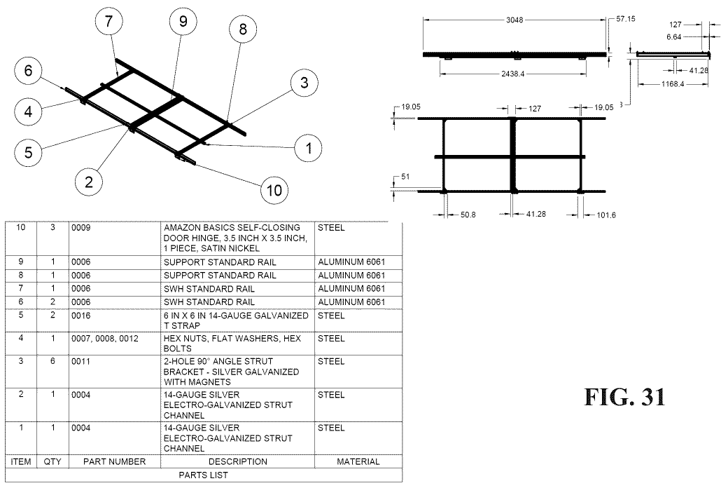

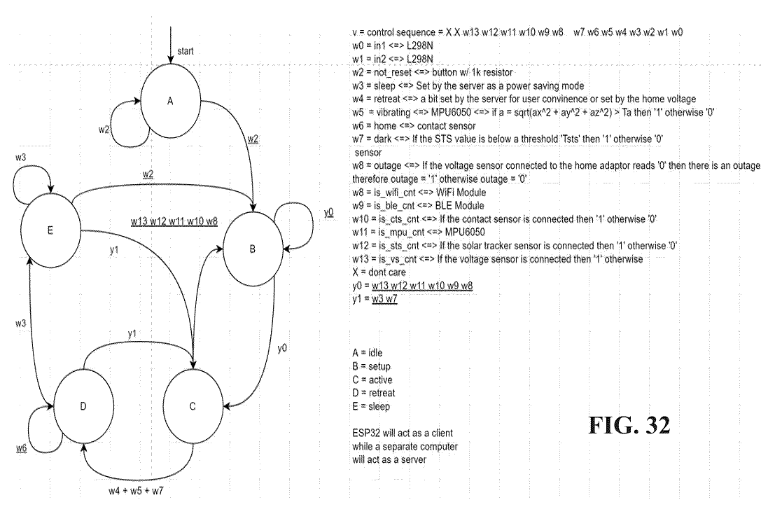

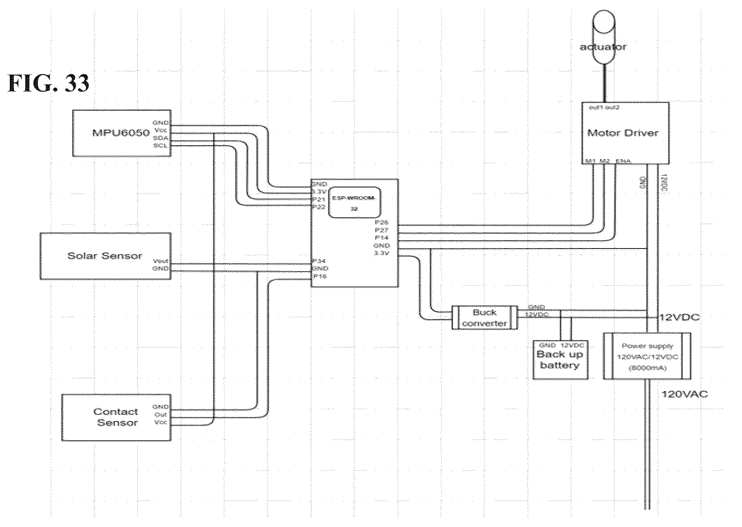

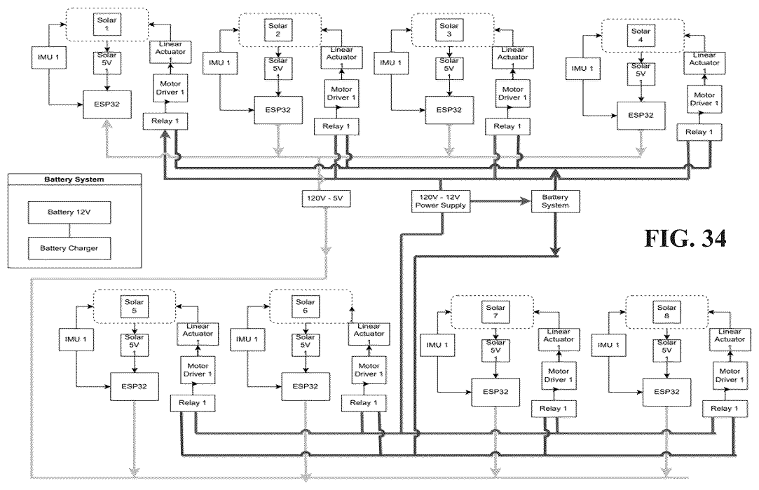

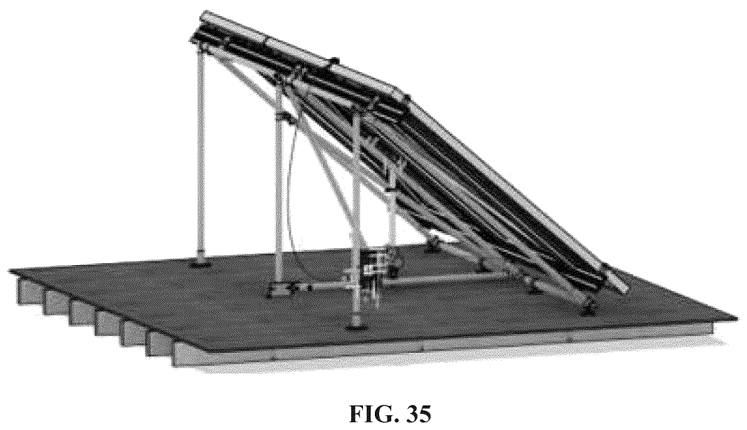

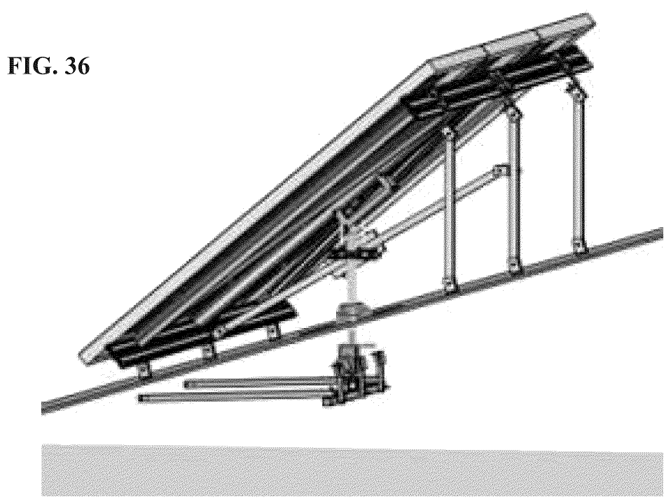

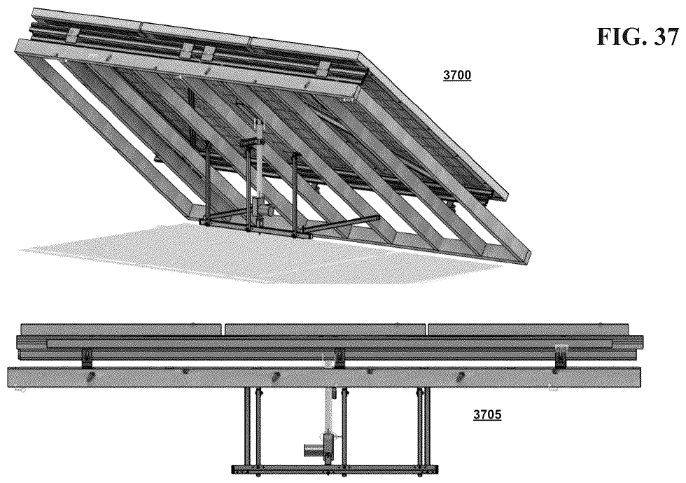

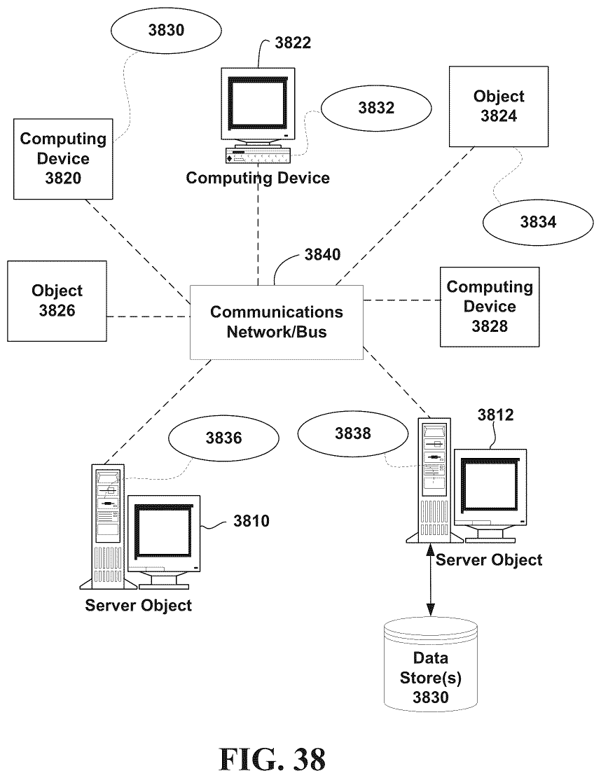

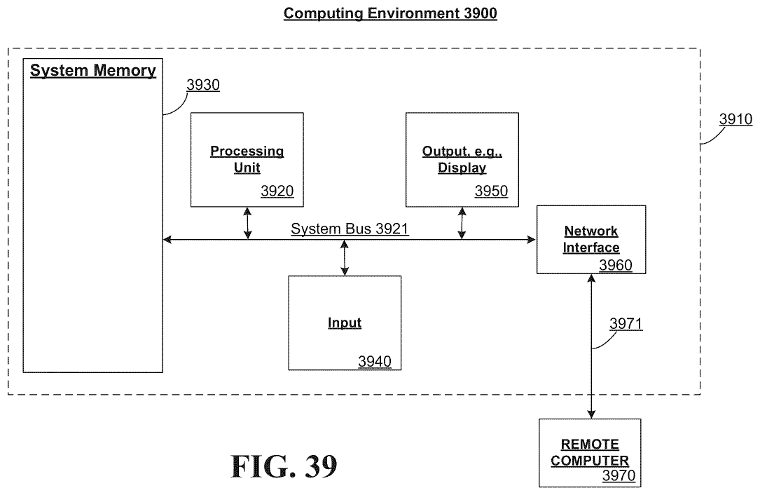

As mentioned, several of the aforementioned embodiments apply to any device wherein it may be desirable to include a computing device to facilitate implementing the aspects disclosed herein. It is understood, therefore, that handheld, portable and other computing devices and computing objects of all kinds are contemplated for use in connection with the various embodiments described herein. Accordingly, the below general purpose remote computer described below in FIG. 31 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 31 thus illustrates an example of a suitable computing system environment 3100 in which one or more of the embodiments may be implemented, although as made clear above, the computing system environment 3100 is only one example of a suitable computing environment and is not intended to suggest any limitation as to the scope of use or functionality of any of the embodiments. The computing environment 3100 is not to be interpreted as having any dependency or requirement relating to any one or combination of components illustrated in the exemplary operating environment 3100.

With reference to FIG. 31, an exemplary remote device for implementing one or more embodiments herein can include a general purpose computing device in the form of a handheld computer 3110. Components of handheld computer 3110 may include, but are not limited to, a processing unit 3120, a system memory 3130, and a system bus 3121 that couples various system components including the system memory to the processing unit 3120.

Computer 3110 typically includes a variety of computer readable media and can be any available media that can be accessed by computer 3110. The system memory 3130 may include computer storage media in the form of volatile and/or nonvolatile memory such as read only memory (ROM) and/or random access memory (RAM). By way of example, and not limitation, memory 3130 may also include an operating system, application programs, other program modules, and program data.

A user may enter commands and information into the computer 3110 through input devices 3140 A monitor or other type of display device is also connected to the system bus 3121 via an interface, such as output interface 3150. In addition to a monitor, computers may also include other peripheral output devices such as speakers and a printer, which may be connected through output interface 3150.

The computer 3110 may operate in a networked or distributed environment using logical connections to one or more other remote computers, such as remote computer 3170. The remote computer 3170 may be a personal computer, a server, a router, a network PC, a peer device or other common network node, or any other remote media consumption or transmission device, and may include any or all of the elements described above relative to the computer 3110. The logical connections depicted in FIG. 31 include a network 3171, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to implement the aspects disclosed herein.

There are multiple ways of implementing one or more of the embodiments described herein, e.g., an appropriate API, tool kit, driver code, operating system, control, standalone or downloadable software object, etc. which enables applications to implement the aspects disclosed herein. Embodiments may be contemplated from the standpoint of an API (or other software object), as well as from a software or hardware object that facilitates implementing the aspects disclosed herein in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment.

What is claimed is:

1. A solar panel system, comprising:
an array component comprising an array of tiltable solar panel units;
a monitoring component configured to monitor environmental conditions proximate to the array of tiltable solar panel units; and
an adjustment component configured to adjust an orientation of the array of tiltable solar panel units based on the environmental conditions.

2. The solar panel system of claim 1, wherein the monitoring component is configured to monitor a position of the sun relative to the orientation of the array of tiltable solar panel units, and wherein the adjustment component configured to adjust the orientation of the array of tiltable solar panel units based on the position of the sun.

3. The solar panel system of claim 1, wherein the monitoring component is configured to monitor wind conditions relative to the orientation of the array of tiltable solar panel units, and wherein the adjustment component is configured to adjust the orientation of the array of tiltable solar panel units based on the wind conditions.

4. The solar panel system of claim 3, wherein the monitoring component is configured to determine whether a metric of the wind conditions relative to the orientation of the array of tiltable solar panel units exceeds a threshold, and wherein the adjustment component is configured to adjust the orientation of the array of tiltable solar panel units into a neutral position in response to the wind conditions exceeding the threshold.

5. The solar panel system of claim 1, wherein the array of tiltable solar panel units are coupled to a flat roof.

6. The solar panel system of claim 1, wherein the array of tiltable solar panel units are coupled to a pitched roof.

7. The solar panel system of claim 1, wherein the adjustment component is configured to adjust a height of at least one of the array of tiltable solar panel units.

8. The solar panel system of claim 7, wherein the adjustment component is configured to adjust a height of a first set of the array of tiltable solar panel units to be different than a height of a second set of the array of tiltable solar panel units.

9. The solar panel system of claim 1, wherein the adjustment component is configured to adjust the orientation of the array of tiltable solar panel units in a plurality of axes.

10. The solar panel system of claim 9, wherein the adjustment component comprises a ball joint coupled to each of the array of tiltable solar panel units, and wherein the ball joint is configured to adjust the orientation of the array of tiltable solar panel units in the plurality of axes.

11. A method, comprising:
employing a processor to execute computer executable instructions stored on a computer readable storage medium to implement the following acts:
coupling an array of tiltable solar panel units to a roof;
monitoring environmental conditions proximate to the array of tiltable solar panel units; and
adjusting an orientation of the array of tiltable solar panel units based on the environmental conditions.

12. The method of claim 11, wherein the monitoring comprises monitoring a position of the sun relative to the orientation of the array of tiltable solar panel units, and wherein the adjusting comprises adjusting the orientation of the array of tiltable solar panel units based on the position of the sun.

13. The method of claim 11, wherein the monitoring comprises monitoring wind conditions relative to the orientation of the array of tiltable solar panel units, and wherein the adjusting comprises adjusting the orientation of the array of tiltable solar panel units based on the wind conditions.

14. The method of claim 13, wherein the monitoring comprises determining whether a metric of the wind conditions relative to the orientation of the array of tiltable solar panel units exceeds a threshold, and wherein the adjusting comprises adjusting the orientation of the array of tiltable solar panel units into a neutral position in response to the wind conditions exceeding the threshold.

15. The method of claim 11, wherein the monitoring comprises monitoring moisture conditions proximate to the array of tiltable solar panel units, and wherein the adjusting comprises adjusting the orientation of the array of tiltable solar panel units based on the moisture conditions.

16. The method of claim 11, wherein the monitoring comprises monitoring temperature conditions proximate to the array of tiltable solar panel units, and wherein the adjusting comprises adjusting the orientation of the array of tiltable solar panel units based on the temperature conditions.

17. The method of claim 1, wherein the array of tiltable solar panel units are coupled to a flat roof.

18. The method of claim 1, wherein the array of tiltable solar panel units are coupled to a pitched roof.

19. The method of claim 1, wherein the adjustment component is configured to adjust a height of at least one of the array of tiltable solar panel units.

20. A solar panel apparatus, comprising:
a frame unit comprising at least one solar panel;
an actuator configured to lift and lower the frame unit, wherein the actuator further comprises a wheel attachment configured to facilitate a tilting of the frame unit that varies as the actuator lifts and lowers the frame unit.
